(19) United States
(12) Patent Application Publication
(10) Pub. No.: US 2026/0134878 A1
(43) Pub. Date: May 14, 2026

(54) SOUND SOURCE SEPARATION METHOD AND APPARATUS

(71) Applicant: Beijing Zitiao Network Technology Co., Ltd., Beijing (CN)

(72) Inventors: Xianjun XIA, Sydney (AU); Zihan ZHANG, Beijing (CN); Chuanzeng HUANG, Beijing (CN)

(21) Appl. No.: 19/382,209

(22) Filed: Nov. 6, 2025

(30) Foreign Application Priority Data
Nov. 8, 2024 (CN) 202411595330.X

(51) Int. Cl. G10L 21/0308; G10L 25/18

(52) U.S. Cl. CPC G10L 21/0308; G10L 25/18

(57) ABSTRACT

Embodiments of this application provide a sound source separation method and apparatus, and relates to the technical field of data processing. The method includes: transforming an audio signal to be separated from a time-domain signal into a time-frequency domain signal; performing frequency band segmentation on the time-frequency domain signal to segment the time-frequency domain signal into a plurality of sub band signals, where frequency bands of the plurality of sub band signals do not overlap; acquiring spectrum features of the plurality of sub band signals respectively; acquiring a spectral mask of at least one sound source of the audio signal to be separated according to the spectrum features of the plurality of sub band signals; and acquiring an audio signal of the at least one sound source according to the spectral mask of the at least one sound source and the time-frequency domain signal.

### CROSS-REFERENCE TO RELATED APPLICATION(S)

This application claims priority to Chinese Application No. 202411595330.X filed Nov. 8, 2024, the disclosure of which is incorporated herein by reference in its entirety.

### FIELD

This application relates to the technical field of audio processing, and in particular, to a sound source separation method and apparatus.

### BACKGROUND

Sound source separation is also known as audio signal source separation or audio source separation, which is an audio processing technology for separating individual sound source components from mixed audio signals.

### SUMMARY

In view of this, embodiments of this application provide a sound source separation method and apparatus to enhance the robustness of a sound source separation algorithm.

To achieve the above-mentioned objective, the embodiments of this application provide the following technical solutions.

In a first aspect, an embodiment of this application provides a sound source separation method. The method includes:
transforming an audio signal to be separated from a time-domain signal into a time-frequency domain signal;
performing frequency band segmentation on the time-frequency domain signal to segment the time-frequency domain signal into a plurality of sub band signals, and frequency bands of the plurality of sub band signals are not overlapped;
acquiring spectrum features of the plurality of sub band signals respectively;
acquiring a spectral mask of at least one sound source of the audio signal to be separated according to the spectrum features of the plurality of sub band signals; and
acquiring an audio signal of the at least one sound source according to the spectral mask of the at least one sound source and the time-frequency domain signal.

As an optional implementation of this embodiment of this application, transforming the audio signal to be separated from the time-domain signal into the time-frequency domain signal includes:
performing a short-time Fourier transform on the audio signal to be separated to transform the audio signal to be separated from the time-domain signal into the time-frequency domain signal.

As an optional implementation of this embodiment of this application, performing the frequency band segmentation on the time-frequency domain signal to segment the time-frequency domain signal into the plurality of sub band signals includes:
performing frequency band segmentation on a first frequency band of the time-frequency domain signal based on a first frequency band interval and performing frequency band segmentation on a second frequency band of the time-frequency domain signal based on a second frequency band interval,
where a maximum frequency of the first frequency band is less than a minimum frequency of the second frequency band, and the first frequency band interval is smaller than the second frequency band interval.

As an optional implementation of this embodiment of this application, acquiring the spectrum features of the plurality of sub band signals respectively includes:
performing feature extraction on the plurality of sub band signals respectively to acquire sub band features of each sub band signal;
stacking the sub band features of each sub band signal to acquire stacked features; and
acquiring the spectrum features of each sub band signal according to the stacked features.

As an optional implementation of this embodiment of this application, performing the feature extraction on the plurality of sub band signals respectively to acquire the sub band features of each sub band signal includes:
performing feature extraction on each sub band signal by a multi-layer perceptron corresponding to each sub band signal to acquire the sub band features of each sub band signal,
where the multi-layer perceptron corresponding to each sub band signal is composed of a root-mean-square normalization layer and a linear layer which are sequentially connected in series.

As an optional implementation of this embodiment of this application, acquiring the spectrum features of each sub band signals according to the stacked features includes:
modeling, by a local feature extraction module, each sub band feature of the stacked features in a time dimension to acquire local features composed of temporal features of each sub band signal;
performing a transposition operation on the local features to acquire first transposed features;
modeling, by a global feature extraction module, each temporal feature of the first transposed features in a feature stacking dimension to acquire global features composed of frequency band features of each sub band signal;
performing a transposition operation on the global features to acquire second transposed features;
performing feature fusion on the second transposed features based on a multi-head self-attention mechanism to acquire a fused feature; and
splitting the fused feature to acquire spectrum features of each sub band signal.

As an optional implementation of this embodiment of this application, the local feature extraction module and/or the global feature extraction module is a dual-path Mamba module. The dual-path Mamba module includes:
a first path, where the first path includes: a first Mamba block, a first root-mean-square normalization layer, and a first adder, an input to the first Mamba block is an input of the dual-path Mamba module, an input to the first root-mean-square normalization layer is an output of the first Mamba block, inputs to the first adder are the output of the first Mamba block and an output of the first root-mean-square normalization layer, and an output of the first adder is an output of the first path;
a second path, where the second path includes: a flipping layer, a second Mamba block, a second root-mean-square normalization layer, and a second adder, the flipping layer is used to flip the input of the dual-path Mamba module, an input to the second Mamba block is an output of the flipping layer, an input to the second root-mean-square normalization layer is an output of the second Mamba block, inputs to the second adder are the output of the second Mamba block and an output of the second root-mean-square normalization layer, and an output of the second adder is an output of the second path;
a concatenation layer, used to concatenate the output of the first path and the output of the second path; and
a linear layer, where an input to the linear layer is an output of the concatenation layer, and an output of the linear layer is an output of the dual-path Mamba module.

As an optional implementation of this embodiment of this application, acquiring the spectral mask of the at least one sound source of the audio signal to be separated according to the spectrum features of the plurality of sub band signals includes:
for each sound source, processing the spectrum features of each sub band signal by a corresponding mask estimation module to acquire a spectral mask of each sub band signal corresponding to the sound source, and concatenating the spectral masks of each sub band signals corresponding to the sound source to acquire the spectral mask of the sound source,
where the mask estimation module corresponding to each sub band is composed of a multi-layer perceptron and a gated linear unit which are sequentially connected in series, and the multi-layer perceptron is composed of a root-mean-square normalization layer and a linear layer which are sequentially connected in series.

As an optional implementation of this embodiment of this application, acquiring the audio signal of the at least one sound source according to the spectral mask of the at least one sound source and the time-frequency domain signal includes:
calculating a product of the time-frequency domain signal and the spectral mask of each sound source respectively to acquire a time-frequency domain signal of each sound source; and
transforming the time-frequency domain signal of each sound source into a time-domain signal respectively to acquire an audio signal of each sound source.

As an optional implementation of this embodiment of this application, transforming the time-frequency domain signal of each sound source into the time-domain signal includes:
performing an inverse short-time Fourier transform on the time-frequency domain signal of each sound source to transform the time-frequency domain signal of each sound source into the time-domain signal.

As an optional implementation of this embodiment of this application, the audio separation method is implemented based on a sound source separation model, and the sound source separation model includes:
a transformation module, configured to perform the step of transforming an audio signal to be separated from a time-domain signal into a time-frequency domain signal;
a segmentation module, configured to perform the step of performing frequency band segmentation on the time-frequency domain signal to segment the time-frequency domain signal into a plurality of sub band signals;
an acquiring module, configured to perform the step of acquiring spectrum features of the plurality of sub band signals respectively;
a mask estimation module, configured to perform the step of acquiring a spectral mask of at least one sound source in the audio signal to be separated according to the spectrum features of the plurality of sub band signals; and
an output module, configured to perform the step of acquiring an audio signal of at least one sound source according to the spectral mask of the at least one sound source and the time-frequency domain signal.

As an optional implementation of this embodiment of this application, before implementing the audio separation method based on the sound source separation model, the method further includes:
acquiring a training data set, where the training data set includes: a plurality of groups of training data, and any group of training data includes: a sample audio signal and a reference audio signal of at least one sound source corresponding to the sample audio signal; and
training the sound source separation model based on the training data set.

As an optional implementation of this embodiment of this application, training the sound source separation model based on the training data set includes:
inputting the sample audio signal into the sound source separation model and acquiring a predicted audio signal of at least one sound source corresponding to the sample audio signal output by the sound source separation model and a time-frequency domain signal of the predicted audio signal of the at least one sound source corresponding to the sample audio signal;
acquiring a time-frequency domain signal of a reference audio signal of the at least one sound source corresponding to the sample audio signal;
calculating a loss value corresponding to the sample audio signal according to the reference audio signal of the at least one sound source corresponding to the sample audio signal, the predicted audio signal of the at least one sound source corresponding to the sample audio signal, the time-frequency domain signal of the predicted audio signal of the at least one sound source corresponding to the sample audio signal, and the time-frequency domain signal of the reference audio signal of the at least one sound source corresponding to the sample audio signal; and
updating model parameters of the sound source separation model according to the loss value.

In a second aspect, an embodiment of this application provides a sound source separation apparatus. The apparatus includes:
a transformation unit, configured to transform an audio signal to be separated from a time-domain signal into a time-frequency domain signal;
a segmentation unit, configured to perform frequency band segmentation on the time-frequency domain signal to segment the time-frequency domain signal into a plurality of sub band signals, frequency bands of the plurality of sub band signals being not overlapped;
an acquiring unit, configured to acquire spectrum features of the plurality of sub band signals respectively;
a processing unit, configured to acquire a spectral mask of at least one sound source in the audio signal to be separated according to the spectrum features of the plurality of sub band signals; and
an output unit, configured to acquire an audio signal of the at least one sound source according to the spectral mask of the at least one sound source and the time-frequency domain signal.

As an optional implementation of this embodiment of this application, the transformation unit is specifically configured to perform a short-time Fourier transform on the audio signal to be separated to transform the audio signal to be separated from a time-domain signal into a time-frequency domain signal.

As an optional implementation of this embodiment of this application, the segmentation unit is specifically configured to perform frequency band segmentation on a first frequency band of the time-frequency domain signal based on a first frequency band interval and perform frequency band segmentation on a second frequency band of the time-frequency domain signal based on a second frequency band interval;
where a maximum frequency of the first frequency band is less than a minimum frequency of the second frequency band, and the first frequency band interval is smaller than the second frequency band interval.

As an optional implementation of this embodiment of this application, the acquiring unit is specifically configured to respectively perform feature extraction on the plurality of sub band signals to acquire sub band features of each sub band signal, stack the sub band features of each sub band signal to acquire stacked features, and acquire spectrum features of each sub band signal according to the stacked features.

As an optional implementation of this embodiment of this application, the acquiring unit is specifically configured to perform feature extraction on each sub band signal through a multi-layer perceptron corresponding to each sub band signal to acquire sub band features of each sub band,
where the multi-layer perceptron corresponding to each sub band signal is composed of a root-mean-square normalization layer and a linear layer which are sequentially connected in series.

As an optional implementation of this embodiment of this application, the acquiring unit is specifically configured to model, by the local feature extraction module, each sub band feature of the stacked features in a time dimension to acquire local features composed of temporal features of each sub band signal; perform a transposition operation on the local features to acquire first transposed features; model, by the global feature extraction module, each temporal feature of the first transposed features in the feature stacking dimension to acquire global features composed of the frequency band features of each sub band signal; perform a transposition operation on the global features to acquire second transposed features; perform feature fusion on the second transposed features by a multi-head self-attention mechanism to acquire a fused feature; and split the fused feature to acquire spectrum features of each sub band signal.

As an optional implementation of this embodiment of this application, the local feature extraction module and/or the global feature extraction module is a dual-path Mamba module. The dual-path Mamba module includes:
a first path, where the first path includes: a first Mamba block, a first root-mean-square normalization layer, and a first adder, an input to the first Mamba block is an input of the dual-path Mamba module, an input to the first root-mean-square normalization layer is an output of the first Mamba block, inputs to the first adder are the output of the first Mamba block and an output of the first root-mean-square normalization layer, and an output of the first adder is an output of the first path;
a second path, where the second path includes: a flipping layer, a second Mamba block, a second root-mean-square normalization layer, and a second adder, the flipping layer is used to flip the input of the dual-path Mamba module, an input to the second Mamba block is an output of the flipping layer, an input to the second root-mean-square normalization layer is an output of the second Mamba block, inputs to the second adder are the output of the second Mamba block and an output of the second root-mean-square normalization layer, and an output of the second adder is an output of the second path;
a concatenation layer, used to concatenate the output of the first path and the output of the second path; and
a linear layer, where an input to the linear layer is an output of the concatenation layer, and an output of the linear layer is an output of the dual-path Mamba module.

As an optional implementation of this embodiment of this application, the processing unit is specifically configured to, for each sound source, process the spectrum features of each sub band signal by the corresponding mask estimation module to acquire a spectral mask of each sub band signal corresponding to the sound source, and concatenate the spectral masks of the sub band signals corresponding to the sound source to acquire a spectral mask of the sound source,
where the mask estimation module corresponding to each sub band is composed of a multi-layer perceptron and a gated linear unit which are sequentially connected in series, and the multi-layer perceptron is composed of a root-mean-square normalization layer and a linear layer which are sequentially connected in series.

As an optional implementation of this embodiment of this application, the output unit is specifically configured to calculate a product of the time-frequency domain signal and the spectral mask of each sound source respectively to acquire a time-frequency domain signal of each sound source; and transform the time-frequency domain signal of each sound source into a time-domain signal respectively to acquire an audio signal of each sound source.

As an optional implementation of this embodiment of this application, the output unit is specifically configured to perform an inverse short-time Fourier transform on the time-frequency domain signal of each sound source to transform the time-frequency domain signal of each sound source into a time-domain signal.

As an optional implementation of this embodiment of this application, the apparatus includes: a sound source separation model. The sound source separation model includes:
a transformation module, configured to transform an audio signal to be separated from a time-domain signal into a time-frequency domain signal;
a segmentation module, configured to implement frequency band segmentation on the time-frequency domain signal;
an acquiring module, configured to acquire spectrum features of the plurality of sub band signals respectively;
a mask estimation module, configured to acquire a spectral mask of at least one sound source in the audio signal to be separated according to the spectrum features of the plurality of sub band signals; and
an output module, configured to acquire an audio signal of the at least one sound source according to the spectral mask of the at least one sound source and the time-frequency domain signal.

As an optional implementation of this embodiment of this application, before the acquiring unit is configured to implement the audio separation method based on the sound source separation model, the method further includes: acquiring a training data set, where the training data set includes: a plurality of groups of training data, and any group of training data includes: a sample audio signal and a reference audio signal of at least one sound source corresponding to the sample audio signal; and training the sound source separation model based on the training data set.

As an optional implementation of this embodiment of this application, the acquiring unit is specifically configured to input the sample audio signal into the sound source separation model and acquire a predicted audio signal of at least one sound source corresponding to the sample audio signal output by the sound source separation model and a time-frequency domain signal of the predicted audio signal of the at least one sound source corresponding to the sample audio signal; acquire a time-frequency domain signal of a reference audio signal of the at least one sound source corresponding to the sample audio signal; calculate a loss value corresponding to the sample audio signal according to the reference audio signal of the at least one sound source corresponding to the sample audio signal, the predicted audio signal of the at least one sound source corresponding to the sample audio signal, the time-frequency domain signal of the predicted audio signal of the at least one sound source corresponding to the sample audio signal, and the time-frequency domain signal of the reference audio signal of the at least one sound source corresponding to the sample audio signal; and update model parameters of the sound source separation model according to the loss value.

In a third aspect, an embodiment of this application provides an electronic device, including one or more memories and one or more processors. The one or more memories are configured to store a computer program. The one or more processors are configured to cause, when executing the computer program, the electronic device to implement the sound source separation method according to any one of the above-mentioned implementations.

In a fourth aspect, an embodiment of this application provides a computer-readable storage medium. A computer program, when executed by a computing device, causes the computing device to implement the sound source separation method according to any one of the above-mentioned implementations.

In a fifth aspect, an embodiment of this application provides a computer program product. The computer program product, when running on a computer, causes the computer to implement the sound source separation method according to any of the above-mentioned implementations.

### BRIEF DESCRIPTION OF THE DRAWINGS

The accompanying drawings herein are incorporated into the specification to form a part of the specification, illustrate embodiments conforming to this application, and are used to explain the principle of this application together with the specification.

In order to more clearly illustrate the technical solutions in the embodiments of this application or in the related art, the accompanying drawings called for describing the embodiments or the related art will be briefly described below. Apparently, those of ordinary skill in the art may still derive other accompanying drawings from these accompanying drawings without creative efforts.

FIG. 1 is a first step flowchart of a sound source separation method according to an embodiment of this application;

FIG. 2 is a schematic structural diagram of a sound source separation model according to an embodiment of this application;

FIG. 3 is a schematic structural diagram of a feature extraction module of a sound source separation model according to an embodiment of this application;

FIG. 4 is a schematic structural diagram of a mask estimation module of a sound source separation model according to an embodiment of this application;

FIG. 5 is a schematic structural diagram of an output module of a sound source separation model according to an embodiment of this application;

FIG. 6 is a second step flowchart of a sound source separation method according to an embodiment of this application;

FIG. 7 is a schematic structural diagram of a dual-path Mamba module according to an embodiment of this application;

FIG. 8 is a schematic structural diagram of a Mamba block according to an embodiment of this application;

FIG. 9 is a schematic structural diagram of a feature processing module of a sound source separation model according to an embodiment of this application;

FIG. 10 is a schematic structural diagram of a sound source separation apparatus according to an embodiment of this application; and

FIG. 11 is a schematic diagram of a hardware structure of an electronic device according to an embodiment of this application.

### DETAILED DESCRIPTION OF EMBODIMENTS

For a clearer understanding of the above-mentioned objectives, features, and advantages of this application, the solutions of this application will be further described below. It should be noted that embodiments in this application and features in the embodiments may be mutually combined without conflicts.

Many specific details are elaborated in the following description to facilitate a full understanding of this application, but this application may also be implemented in methods different from those described herein. Apparently, the embodiments in the specification are only a part rather all of the embodiments of this application.

In the embodiments of this application, terms such as “exemplarily” and “for example” are used for exampling, illustration, or explanation. Any embodiment or design scheme described as “exemplary” or “for example” in the embodiments of this application should not be interpreted as being more preferable or advantageous over other embodiments or design schemes. Exactly, the use of terms like “exemplary” or “for example” is intended to present relevant concepts in a specific manner. Additionally, in the descriptions of the embodiments of this application, unless otherwise specified, “a plurality of” means two or more.

Conventional audio separation solutions mainly rely on signal processing technologies, such as independent component analysis. These solutions implement sound source separation by conducting frequency-domain analysis or time-frequency domain analysis on the audio signals to extract features of one or more sound sources. However, when dealing with complex audio signals, these solutions often struggle to achieve ideal separation effects. With the development of machine learning and deep learning technologies, data-driven solutions have made remarkable progress in the field of sound source separation. By training a deep neural network (DNN), features and modes of sound source separation can be learned from a large amount of audio data, thereby implementing more accurate and efficient sound source separation. However, these algorithms exhibit insufficient robustness when performing sound source separation on different types of audio signals. For example, if a certain audio signal is not included in a training data set, there may be a significant decline in a sound source separation effect on this type of audio signal based on the algorithms.

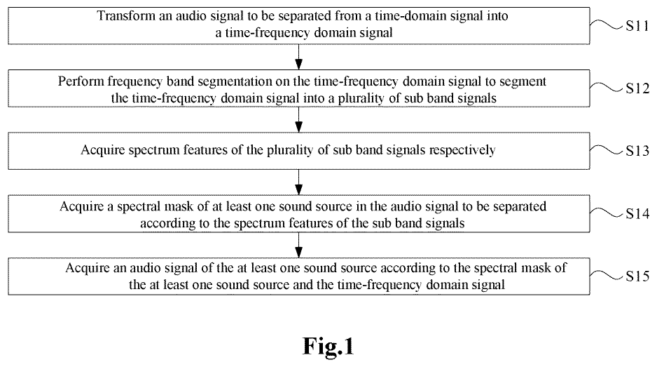

An embodiment of this application provides a sound source separation method. An execution entity of the sound source separation method may be an electronic device such as a mobile phone, a personal computer, a palmtop computer, an in-vehicle device, a server, or a sound source separation apparatus integrated into the electronic device. Referring to FIG. 1, the sound source separation method includes the following steps S11 to S15.

S11: an audio signal to be separated is transformed from a time-domain signal into a time-frequency domain signal.

The audio signal to be separated in this embodiment of this application may be a dual-channel multi-track mixed audio signal, a single-channel multi-track mixed audio signal, a multi-channel multi-track mixed audio signal, etc. A channel refers to an independent pathway for sound recording or playback, serving as a route for an audio system to transmit and process sound information. Each channel may carry an independent audio signal, and these signals may differ in aspects such as spatial location, timbre, and volume. For example, in common stereo audio, there are two channels: a left channel and a right channel, which work together to create a sense of spatiality and dimensionality in sound. A track refers to a channel used for recording, editing, and processing a single audio element or a group of related audio elements. An important function of the soundtrack is to separate different audio elements, thereby facilitating separate editing and processing of the audio elements. Exemplarily, the audio signal to be separated is music.

The time-domain signal is a representation method that describes changes of a signal overtime. The audio signal is a signal with a frequency, an amplitude, and a phase changing over time, and therefore, the audio signal is essentially a time-domain signal. The time-frequency domain signal is a method that describes a signal by simultaneously considering both time and frequency dimensions, thereby revealing frequency components of the signal at different moments and changes of the signal over time.

In some embodiments, the audio signal to be separated may be transformed from the time-domain signal into the time-frequency domain signal through a short-time Fourier transform (STFT) or wavelet transform (WT) on the audio signal to be separated.

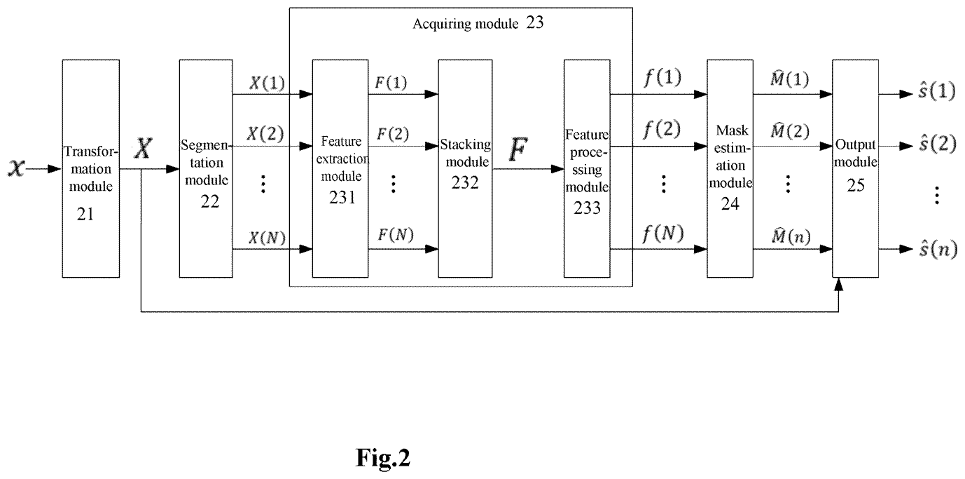

In some embodiments, the audio separation method is implemented based on a sound source separation model. Referring to FIG. 2, the sound source separation model includes a transformation module 21, configured to perform the step of transforming the audio signal x to be separated from the time-domain signal into the time-frequency domain signal X∈R^{C×F×T}.

S12: frequency band segmentation is performed on the time-frequency domain signal to segment the time-frequency domain signal into a plurality of sub band signals.

Frequency bands of the plurality of sub band signals are not overlapped.

That is, the time-frequency domain signal is segmented from the frequency dimension, and the segmented signals are defined as the sub band signals.

In some embodiments, performing the frequency band segmentation on the time-frequency domain signal to segment the time-frequency domain signal into the plurality of sub band signals includes:
performing frequency band segmentation on a first frequency band of the time-frequency domain signal based on a first frequency band interval and performing frequency band segmentation on a second frequency band of the time-frequency domain signal based on a second frequency band interval,
where a maximum frequency of the first frequency band is less than a minimum frequency of the second frequency band, and the first frequency band interval is smaller than the second frequency band interval.

That is, a small frequency band interval is used for frequency band segmentation on a low-frequency band, while a large frequency band interval is used for frequency band segmentation on a high-frequency band.

Since the human ear is more sensitive to low-frequency parts, using the small frequency band interval for frequency band segmentation on the low-frequency band and the large frequency band interval for frequency band segmentation on the high-frequency band may ensure an audio data processing effect while avoiding an excessive data processing amount.

According to the sound source separation method provided in this embodiment of this application, when the sound source separation is performed on the audio signal to be separated, first, the audio signal to be separated is transformed from the time-domain signal into the time-frequency domain signal through the sound source separation model, then, the frequency band segmentation is performed on the time-frequency domain signal to segment the time-frequency domain signal into the plurality of sub band signals with the non-overlapping frequency bands, then, the spectrum features of the sub band signals are respectively acquired, subsequently, the spectral mask of the at least one sound source of the audio signal to be separated is acquired according to the spectrum features of the sub band signals, and the audio signal of the at least one sound source is acquired according to the spectral mask of the at least one sound source and the time-frequency domain signal. According to the sound source separation method provided in this embodiment of this application, the time-frequency domain signal of the audio signal to be separated is segmented into the plurality of sub band signals with the non-overlapping frequency bands, then, the spectrum features of the sub band signals are respectively acquired, and therefore this embodiment of this application may allow the sound source separation model to acquire the spectrum features of the frequency bands in a more detailed manner, and accordingly, this embodiment of this application may enhance the robustness of a sound source separation algorithm.

Referring to FIG. 2, in some embodiments, the sound source separation model further includes: a segmentation module 22. The segmentation module 22 is configured to segment a frequency domain signal X∈R^{C×F×T} into a plurality of sub band signals X(1), X(2) . . . X(N).

S13: spectrum features of the plurality of sub band signals are acquired respectively.

In some embodiments, the audio separation method is implemented based on the sound source separation model. Referring to FIG. 2, the sound source separation model includes: an acquiring module 23. The acquiring module 23 is configured to perform the step of acquiring the spectrum features X(1), X(2) . . . X(N) of the plurality of sub band signals f(1), f(2) . . . f(N) respectively.

In some embodiments, an implementation of step S13 above (acquiring the spectrum features of the plurality of sub band signals respectively) includes the following steps a to c:

Step a: feature extraction is performed on the plurality of sub band signals respectively to acquire sub band features of each sub band signal.

In some embodiments, the sound source separation model includes feature extraction modules corresponding to the sub band signals. Performing the feature extraction on the plurality of sub band signals respectively to acquire the sub band features of each sub band signal includes: inputting each sub band signal into the corresponding feature extraction module and acquiring the sub band features of each sub band signal output by the corresponding feature extraction module for each sub band signal.

In some embodiments, the feature extraction module corresponding to each sub band signal is a multi-layer perceptron (MLP). That is, performing the feature extraction on the plurality of sub band signals respectively to acquire the sub band features of each sub band signal includes: performing the feature extraction on each sub band signal through the multi-layer perceptron (MLP) corresponding to each sub band signal to acquire the sub band features of each sub band signal. The MLP corresponding to each sub band signal is composed of a root-mean-square normalization layer (RMSNorm) and a linear layer, which are sequentially connected in series. The root-mean-square normalization layer is a model structure that performs a normalization operation based on a root-mean-square value of input data, and is used to normalize features of the input data to a specific range, making the data distribution more reasonable and facilitating subsequent processing and analysis. The linear layer, also known as a fully-connected layer, is a basic layer structure in neural networks, and has a main function of mapping an input vector to an output vector through a set of learnable weights and biases, so as to perform a linear transformation on the input data.

Referring to FIG. 2, in some embodiments, the acquiring module 23 includes: a feature extraction module 231. The feature extraction module 231 is configured to perform feature extraction on the plurality of sub band signals respectively to acquire sub band features of each sub band signal F(1), F(2) . . . F(N).

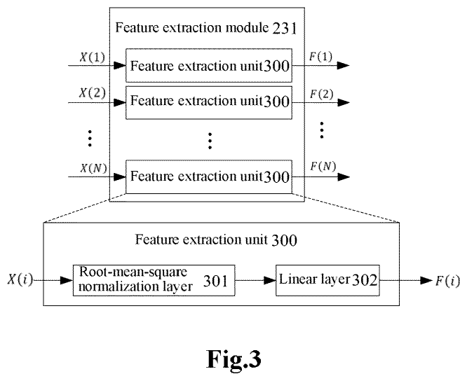

Referring to FIG. 3, in some embodiments, the feature extraction module 231 includes: feature extraction units 300 corresponding to the sub band signals. That is, the feature extraction module 231 includes N feature extraction units 300, where N is the number of sub band signals obtained by frequency band segmentation on the time-frequency domain signal. Each feature extraction unit 300 is composed of a root-mean-square normalization layer 301 and a linear layer 302 which are sequentially connected in series.

Step b: the sub band features of each sub band signal are stacked to acquire stacked features.

In some embodiments, stacking the sub band features of each sub band signal to acquire the stacked features includes: processing the sub band features of each sub band signal into features of the same size, and then stacking the sub band features of each sub band signal in an ascending order of frequency.

Exemplarily, if the sub band features of the sub band signals are processed to have a size of D×T, the stacked features obtained by stacking the sub band features of each sub band signal have a size of N×D×T. D represents the number of feature points, T represents the number of audio frames in the audio signal to be separated, and N represents the number of the sub band signals obtained by frequency band segmentation on the time-frequency domain signal.

Referring to FIG. 2, in some embodiments, the acquiring module 23 further includes: a stacking module 232. The stacking module 232 is configured to stack the sub band features of each sub band signal to acquire stacked features F∈R^{N×D×T}.

Step c: spectrum features of the sub band signals are acquired according to the stacked features.

The spectrum features refer to parameters or attributes extracted from a spectrum (frequency domain representation) of a signal to describe signal frequency characteristics. The spectrum features may include important information such as the distribution of the signal across different frequency components and the degree of energy concentration.

In some embodiments, the stacked features may be input into a state-space model to acquire the spectrum features of the sub band signals output by the state-space model.

Referring to FIG. 2, in some embodiments, the acquiring module 23 further includes: a feature processing module 233. The feature processing module is configured to process the stacked features F∈R^{N×D×T} to acquire spectrum features f(1), f(2) . . . f(N) of the each sub band signal.

S14: a spectral mask of at least one sound source in the audio signal to be separated is acquired according to the spectrum features of each sub band signal.

In some embodiments, the audio signal to be separated is music, and the at least one sound source may include human voice and instruments such as bass, a drum, and a guitar.

In some embodiments, the sound source separation model includes a mask estimation module corresponding to each sub band signal. Acquiring the spectral mask of the at least one sound source in the audio signal to be separated according to the spectrum features of the sub band signals includes: for each sound source, processing the spectrum features of each sub band signal through the corresponding mask estimation module to acquire a spectral mask of each sub band signal corresponding to the sound source, and concatenating the spectral masks of the sub band signals corresponding to the sound source to acquire the spectral mask of the sound source. The mask estimation module corresponding to each sub band is composed of an MLP and a gated linear unit (GLU). The MLP is composed of a root-mean-square normalization layer and a linear layer which are sequentially connected in series.

In some embodiments, the sound source separation method is implemented based on the sound source separation model. Referring to FIG. 2, the sound source separation model further includes a mask estimation module 24. The mask estimation module 24 is configured to acquire a spectral mask \hat{M}(1), \hat{M}(2) . . . \hat{M}(n) of at least one sound source in the audio signal to be separated according to the spectrum features of the sub band signals, where n is the number of sound sources.

Referring to FIG. 4, in some embodiments, the mask estimation module 24 includes a mask estimation structure 240 corresponding to each sound source. The mask estimation structure 240 corresponding to any sound source includes: N mask estimation units 41 and a concatenation layer 42. Each mask estimation unit 41 is composed of an MLP 411 and a GLU 412, which are sequentially connected in sequence. The concatenation layers 42 are used to concatenate the spectral masks of the sub bands output by the N mask estimation units 41 to acquire the spectral mask of the sound source. N is the number of sub band signals obtained by frequency band segmentation on the time-frequency domain signal.

S15: an audio signal of at least one sound source is acquired according to the spectral mask of the at least one sound source and the time-frequency domain signal.

Referring to FIG. 2, in some embodiments, the sound source separation model further includes: an output module 25. The output module 25 is configured to acquire an audio signal of at least one sound source according to the spectral mask of at least one sound source and the time-frequency domain signal.

In some embodiments, acquiring the audio signal of the at least one sound source according to the spectral mask of the at least one sound source and the time-frequency domain signal includes: calculating a product of the time-frequency domain signal and the spectral mask of each sound source respectively to acquire a time-frequency domain signal of each sound source; and transforming the time-frequency domain signal of each sound source into a time-domain signal respectively to acquire an audio signal of each sound source.

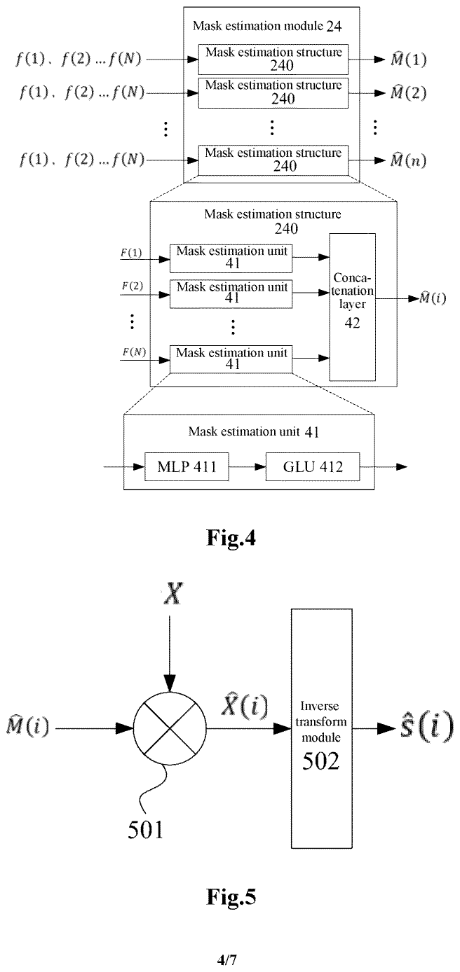

Referring to FIG. 5, in some embodiments, the output module 25 includes: a multiplier 501 and an inverse transform module 502. The multiplier 501 is used to calculate a product of the time-frequency domain signal and a spectral mask of a sound source, to output a time-frequency domain signal \hat{X}(1), \hat{X}(2) . . . \hat{X}(n) of the sound source. The inverse transform module 502 is configured to perform an inverse transform on the time-frequency domain signal of the sound source to obtain a time-domain signal, thereby acquiring an audio signal ŝ(1), ŝ(2) . . . ŝ(n) of each sound source. \hat{X}(i)ŝ(i)

According to the sound source separation method provided in this embodiment of this application, when the sound source separation is performed on the audio signal to be separated, first, the audio signal to be separated is transformed from the time-domain signal into the time-frequency domain signal through the sound source separation model, then, the frequency band segmentation is performed on the time-frequency domain signal to segment the time-frequency domain signal into the plurality of sub band signals with the non-overlapping frequency bands, then, the spectrum features of the sub band signals are respectively acquired, subsequently, the spectral mask of the at least one sound source of the audio signal to be separated is acquired according to the spectrum features of the sub band signals, and the audio signal of the at least one sound source is acquired according to the spectral mask of the at least one sound source and the time-frequency domain signal. According to the sound source separation method provided in this embodiment of this application, the time-frequency domain signal of the audio signal to be separated is segmented into the plurality of sub band signals with the non-overlapping frequency bands, then, the spectrum features of the sub band signals are respectively acquired, and therefore this embodiment of this application may allow the sound source separation model to acquire the spectrum features of the frequency bands in a more detailed manner, and accordingly, this embodiment of this application may enhance the robustness of a sound source separation algorithm.

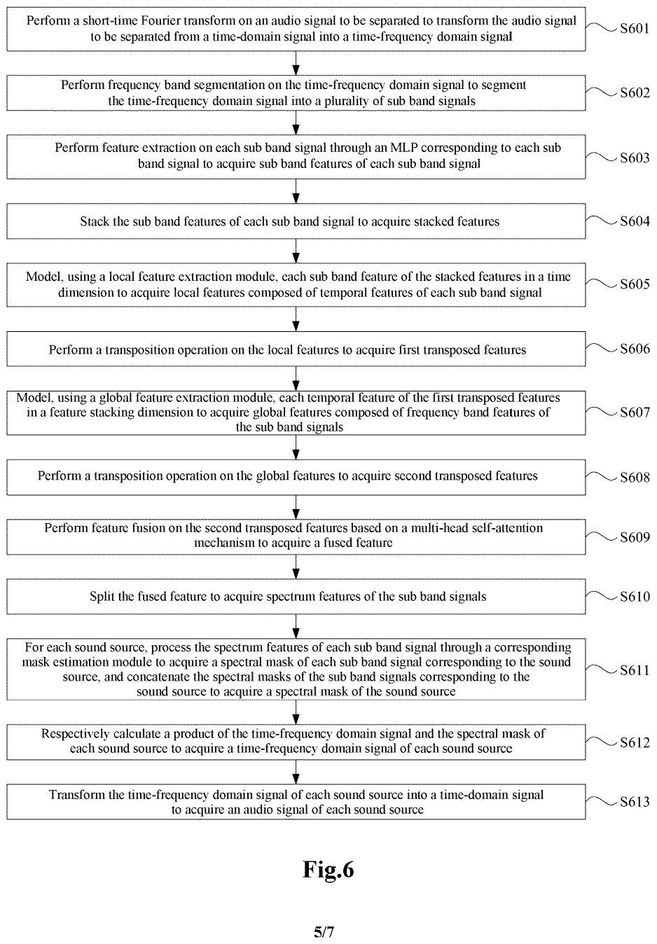

As an extension and refinement of the above-mentioned embodiments, an embodiment of this application further provides another sound source separation method. Referring to FIG. 6, the sound source separation method includes the following steps:

S601: a short-time Fourier transform is performed on an audio signal to be separated to transform the audio signal to be separated from a time-domain signal into a time-frequency domain signal.

The short-time Fourier transform is a signal processing technology that performs windowing processing on a signal. When the short-time Fourier transform is performed on the audio signal to be separated, a suitable window function is first set for the audio signal to be separated. A length of the window function determines a sampling rate for the audio signal to be separated. Then, the window function slides along a time axis, and the Fourier transform is performed on the audio signal to be separated within each window, thereby obtaining spectra of the audio signal to be separated at different time segments (determined by the window function), and thus converting the audio signal to be separated from the time domain signal to the time-frequency domain signal.

S602: frequency band segmentation is performed on the time-frequency domain signal to segment the time-frequency domain signal into a plurality of sub band signals.

In some embodiments, performing the frequency band segmentation on the time-frequency domain signal to segment the time-frequency domain signal into the plurality of sub band signals includes: selecting a preset number of frequency band segmentation points on the time-frequency domain signal, segmenting the time-frequency domain signal into a plurality of frequency bands based on the selected frequency band segmentation points, and then segmenting each frequency band based on a frequency band interval corresponding to each frequency band, to segment the time-frequency domain signal into the plurality of sub band signals.

For example, five frequency band segmentation points are selected on the time-frequency domain signal, the time-frequency domain signal is segmented into six frequency bands based on the five selected frequency band segmentation points, and then each frequency band is segmented based on a frequency band interval corresponding to each frequency band.

Exemplarily, the five frequency band segmentation points may be 1000 kHz, 2000 kHz, 4000 kHz, 8000 kHz, and 16000 kHz respectively. The six frequency bands obtained by segmenting the time-frequency domain signal based on 1000 kHz, 2000 kHz, 4000 kHz, 8000 kHz, and 16000 kHz are: a first frequency band less than 1000 Hz, a second frequency band [1000 Hz, 2000 Hz), a third frequency band [2000 Hz, 4000 Hz), a fourth frequency band [4000 Hz, 8000 Hz), a fifth frequency band [8000 Hz, 16000 Hz), and a sixth frequency band greater than or equal to 16000 Hz.

Exemplarily, the five frequency band segmentation points may also be 2000 kHz, 4000 kHz, 6000 kHz, 8000 kHz, and 10000 kHz respectively. The six frequency bands obtained by segmenting the time-frequency domain signal based on 2000 kHz, 4000 kHz, 6000 kHz, 8000 kHz, and 10000 kHz are: a first frequency band less than 2000 Hz, a second frequency band [2000 Hz, 4000 Hz), a third frequency band [4000 Hz, 6000 Hz), a fourth frequency band [6000 Hz, 8000 Hz), a fifth frequency band [8000 Hz, 10000 Hz), and a sixth frequency band greater than or equal to 10000 Hz.

In some embodiments, the frequency band intervals corresponding to the frequency bands increase sequentially.

For example, the first frequency band of the time-frequency domain signal may be evenly segmented into 24 sub band signals based on the frequency band interval corresponding to the first frequency band; the second frequency band of the time-frequency domain signal is evenly segmented into 12 sub band signals based on the frequency band interval corresponding to the second frequency band; the third frequency band of the time-frequency domain signal is evenly segmented into 8 sub band signals based on the frequency band interval corresponding to the third frequency band; the fourth frequency band of the time-frequency domain signal is evenly segmented into 8 sub band signals based on the frequency band interval corresponding to the fourth frequency band; the fifth frequency band of the time-frequency domain signal is evenly segmented into 8 sub band signals based on the frequency band interval corresponding to the first frequency band; and the sixth frequency band of the time-frequency domain signal is evenly segmented into 2 sub band signals based on the frequency band interval corresponding to the first frequency band. That is, the time-frequency domain signal is segmented into 62 sub band signals by the above-mentioned segmentation solution.

S603: feature extraction is performed on each sub band signal by an MLP corresponding to each sub band signal to acquire sub band features of each sub band signal.

The MLP corresponding to each sub band signal is composed of a root-mean-square normalization layer and a linear layer, which are sequentially connected in series.

Step 604: the sub band features of each sub band signal are stacked to acquire stacked features.

S605: each sub band feature of the stacked features is modeled by a local feature extraction module in a time dimension to acquire local features composed of temporal features of each sub band signal.

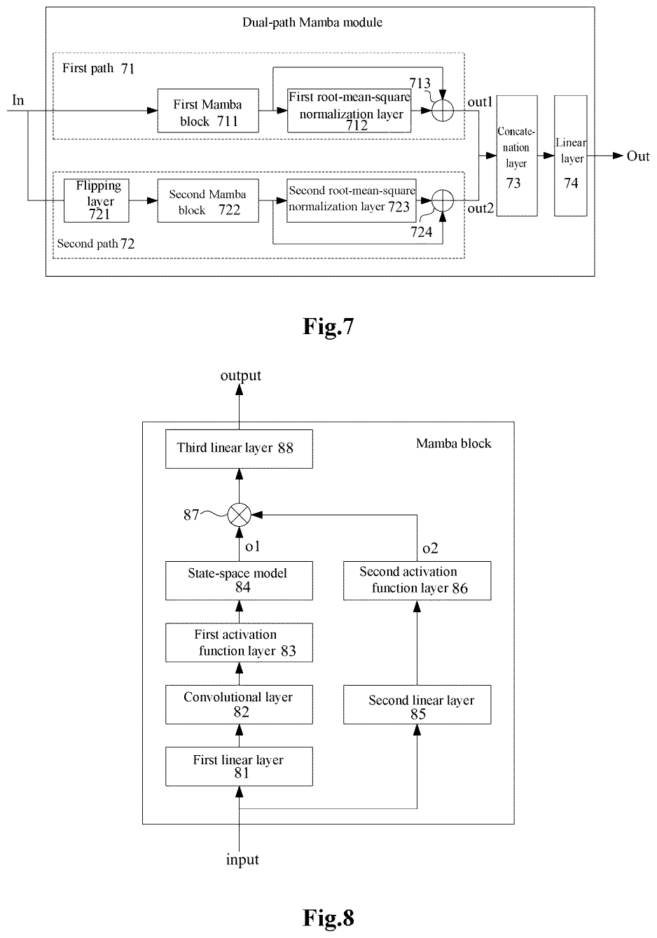

In some embodiments, the local feature extraction module is a dual-path Mamba module. Referring to FIG. 7, the dual-path Mamba module includes:
a first path 71, where the first path 71 includes: a first Mamba block 711, a first root-mean-square normalization layer 712, and a first adder 713, an input to the first Mamba block 711 is an input In of the dual-path Mamba module, an input to the first root-mean-square normalization layer 712 is an output of the first Mamba block 711, inputs to the first adder 713 are the output of the first Mamba block and an output of the first root-mean-square normalization layer 712, and an output of the first adder 713 is an output out1 of the first path;
a second path 72, where the second path includes: a flipping layer 721, a second Mamba block 722, a second root-mean-square normalization layer 723, and a second adder 724, the flipping layer 721 is used to flip the input In of the dual-path Mamba module, an input to the second Mamba block 722 is an output of the flipping layer 721, an input to the second root-mean-square normalization layer 723 is an output of the second Mamba block, inputs to the second adder 724 are the output of the second Mamba block and an output of the second root-mean-square normalization layer 723, and an output of the second adder 724 is an output out2 of the second path;
a concatenation layer 73, configured to concatenate the output out1 of the first path and the output out2 of the second path; and
a linear layer 74, where an input to the linear layer 74 is an output of the concatenation layer 73, and an output of the linear layer is an output of the dual-path Mamba module.

The Mamba block is a neural network structure built with the state-space model (SSM) as a core module. Within the Mamba block, sequence data is regarded as a dynamic system, where each element in a sequence corresponds to an input or output of the system at a specific moment.

Referring to FIG. 8, in some embodiments, the Mamba block includes: a first linear layer 81, a convolutional layer 82, a first activation function layer 83, a state-space model 84, a second linear layer 85, a second activation function layer 86, a multiplier 87, and a third linear layer 88. The first linear layer 81, the convolutional layer 82, the first activation function layer 83, and the state-space model 84 are sequentially connected in series to process the input of the Mamba block. The second linear layer 85 and the second activation function layer 86 are sequentially connected in series to process the input of the Mamba block. The multiplier 87 is used to calculate a product of an output o1 of the state-space model 84 and an output o2 of the second activation function layer 86. The third linear layer 88 is used to perform linear mapping on the output of the multiplier 87 to obtain an output of the Mamba block.

For a continuous system, the state-space model 84 is described using a system input, a system output, and a state variable. The system input x(t) is mapped to the system output y(t) through a hidden state h(t). A mapping process may be represented by a formula:

$${h}^{′} ( t ) = A h ( t ) + B x ( t )$$

$$y ( t ) = {Ch}^{′} ( t )$$

A represents a state transition matrix of the state-space model 84, B represents a mapping matrix from the input to the state variable of the state-space model 84, and C represents a mapping matrix from the state variable to the output of the state-space model 84.

In the Mamba block, the state-space model is input-selective. That is, A. B. and C are functions related to the system input x(t) and are updated according to an input at each time step, thereby allowing the state-space model to selectively propagate or forget information based on system input content, and thus enhancing the expressive capability of the model.

In the above-mentioned embodiments, the local feature extraction module is the dual-path Mamba module. Therefore, the above-mentioned embodiments can fully utilize historical information and future information to improve the accuracy of sound source separation.

S606: a transposition operation is performed on the local features to acquire first transposed features.

Exemplarily, if a feature tensor of the local features is N×D×T, a feature tensor of the first transposed features is T×D×N.

S607: each temporal feature of the first transposed features is modeled by a global feature extraction module in a feature stacking dimension to acquire global features composed of the frequency band features of the sub band signals.

In some embodiments, the global feature extraction module is a dual-path Mamba module. For a structure and a working principle of the dual-path Mamba module, reference may be made to the local feature extraction module. To avoid repetition, repeated descriptions are omitted herein.

S608: a transposition operation is performed on the global features to acquire second transposed features.

Exemplarily, if a feature tensor of the global features is T×D×N, a feature tensor of the second transposed features is N×D×T.

S609: feature fusion is performed on the second transposed features based on a multi-head self-attention (MHSA) mechanism to acquire a fused feature.

The multi-head self-attention mechanism is a type of self-attention mechanism, and has a working principle that in a self-attention calculation of each head, an attention score is obtained by calculating a dot product of a query vector and a key vector, the score reflects a degree of importance of each element to a current element, and a value vector is an object subjected to a weighted summation according to the attention score. The plurality of heads work in parallel, and each head may focus on different aspects. Outputs of these different heads are integrated through concatenation or other fusion methods, such that a final output contains information from a plurality of angles, providing a more comprehensive representation of an input sequence.

S610: the fused feature is split to acquire spectrum features of the sub band signals.

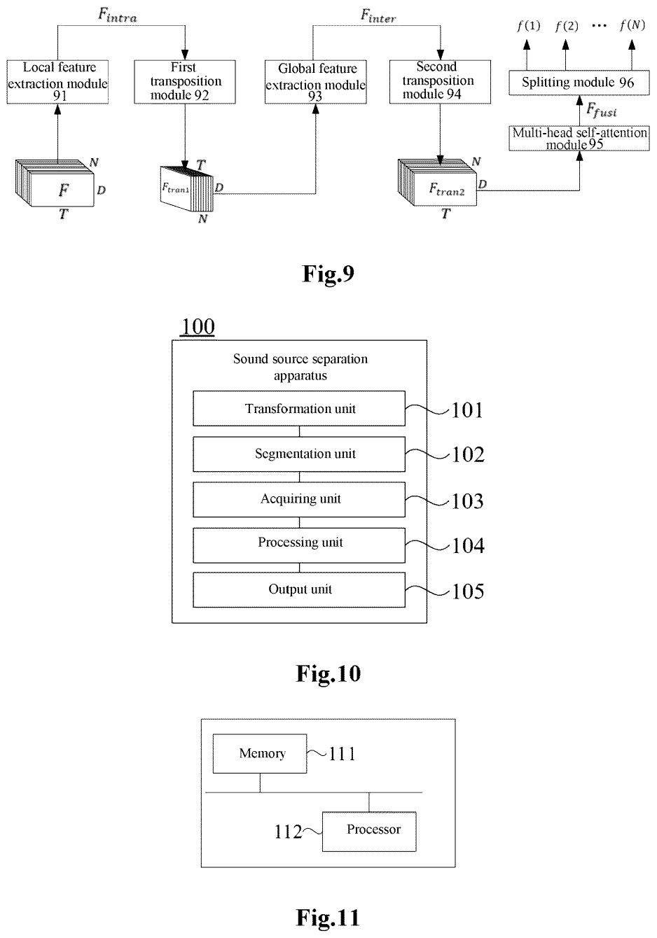

Referring to FIG. 9, the feature processing module in the sound source separation model for implementing the above-mentioned steps S605 to S610 includes: a local feature extraction module 91, a first transposition module 92, a global feature extraction module 93, a second transposition module 94, a multi-head self-attention module 95, and a splitting module 96. The local feature extraction module 91 is configured to model each sub band feature of the stacked features F in a time dimension to acquire local features Fᵢₙₜᵣₐ composed of temporal features of each sub band signal. The first transposition module 92 is configured to perform a transposition operation on the local features Fᵢₙₜᵣₐ to acquire first transposed features Fₜᵣₐₙ₁. The global feature extraction module 93 is configured to model each temporal feature of the first transposed features Fₜᵣₐₙ₁ in a feature stacking dimension to acquire global features Fᵢₙₜₑᵣ composed of the frequency band features of the sub band signals. The second transposition module 94 is configured to perform a transposition operation on the global features Fᵢₙₜₑᵣ to acquire second transposed features Fₜᵣₐₙ₂. The multi-head self-attention module 95 is configured to process the second transposed features Fₜᵣₐₙ₂ based on a multi-head self-attention mechanism to acquire a fused feature F_{fusi}. The splitting module 96 is configured to split the fused feature F_{fusi} to acquire spectrum features f(1), f(2) . . . f(N) of the sub band signals.

S611: For each sound source, the spectrum features of each sub band signal are processed by the corresponding mask estimation module to acquire a spectral mask of each sub band signal corresponding to the sound source, and the spectral masks of the sub band signals corresponding to the sound source are concatenated to acquire a spectral mask of the sound source.

The mask estimation module corresponding to each sub band is composed of an MLP and a GLU, which are sequentially connected in series. The MLP is composed of a root-mean-square normalization layer and a linear layer, which are sequentially connected in series.

S612: a product of the time-frequency domain signal and the spectral mask of each sound source is calculated respectively to acquire a time-frequency domain signal of each sound source.

S613: the time-frequency domain signal of each sound source is transformed into a time-domain signal respectively to acquire an audio signal of each sound source.

In some embodiments, transforming the time-frequency domain signal of each sound source into the time-domain signal to acquire the audio signal of each sound source includes: performing an inverse short-time Fourier transform (ISTFT) on the time-frequency domain signal of each sound source to transform the time-frequency domain signal of each sound source into a time-domain signal.

The sound source separation method provided in this embodiment of this application further includes training the sound source separation model before transforming the audio signal to be separated from the time-domain signal into the time-frequency domain signal (i.e., before starting the sound source separation on the audio signal to be separated). In some embodiments, training the sound source separation model includes: acquiring a training data set and training the sound source separation model based on the training data set. The training data set includes: a plurality of groups of training data, and any group of training data includes: a sample audio signal and a reference audio signal of at least one sound source corresponding to the sample audio signal.

In some embodiments, training the sound source separation model based on the training data set includes the following steps a to d:

Step a: the sample audio signal is input into the sound source separation model and a predicted audio signal of at least one sound source corresponding to the sample audio signal output by the sound source separation model is acquired.

That is, the steps of transforming from the time-domain signal to the time-frequency domain signal and the frequency band segmentation are first performed by the sound source separation model, to acquire the spectral mask of the at least one sound source. Then, the spectral mask of the sound source is applied to a time-frequency domain signal of sample audio to acquire an audio time-frequency domain signal of the sound source, and finally, the inverse short-time Fourier transform is performed on the time-frequency domain signal of the audio to acquire the predicted audio signal of the sound source.

An implementation process of step a may also be summarized by the following formula:

$$\hat{S} ( t ) = X ( t ) * \hat{M} ( t )$$

$$\hat{s} ( t ) = ISTFT ( \hat{S} ( t ) )$$

X(t) represents the time-frequency domain signal of the sample audio, \hat{M}(t) represents a spectral mask of a sound source t, Ŝ(t) represents a time-frequency domain signal of the sound source t, ISTFT( ) represents the inverse short-time Fourier transform operation, and ŝ(t) represents a predicted audio signal of the sound source t.

Step b: a time-frequency domain signal of a reference audio signal of at least one sound source corresponding to the sample audio signal is acquired.

In some embodiments, the short-time Fourier transform may be respectively performed on the reference audio signal of each sound source corresponding to the sample audio signal, to acquire the time-frequency domain signal of the reference audio signal of the at least one sound source corresponding to the sample audio signal.

Step c: a loss value corresponding to the sample audio signal according to the reference audio signal of the at least one sound source corresponding to the sample audio signal, the predicted audio signal of the at least one sound source corresponding to the sample audio signal, the time-frequency domain signal of the predicted audio signal of the at least one sound source corresponding to the sample audio signal, and the time-frequency domain signal of the reference audio signal of the at least one sound source corresponding to the sample audio signal is calculated.

In some embodiments, a loss function used to calculate the loss value corresponding to the sample audio signal is as follows:

$${L}_{MAE} = {\sum }_{i = 0}^{N} \vert {s}_{i} - {\hat{s}}_{i} \vert$$

$${L}_{STST} = \vert {\vert S ( t , f ) - \hat{S} ( t , f ) \vert}^{p} \vert + \vert {\vert S ( t , f ) \vert}^{p} {e}^{j Ψ S ( t , f )} - {\vert \hat{S} ( t , f ) \vert}^{p} {e}^{j Ψ S ( t , f )} \vert$$

$${L}_{ALL} = {L}_{MAE} + {L}_{STFT}$$

s and ŝ represent the reference audio signal and the predicted audio signal of the sound source respectively, S and Ŝ represent the time-frequency domain signals of the reference audio signal and the predicted audio signal of the sound source respectively, and t, f represent a time index and a frequency index respectively; and |S(t, f)| represents a modulus taken a frequency point of the reference audio signal of the sound source, namely, an amplitude value of the reference audio signal of the sound source. A hyperparameter p may be set to 0.3, that is, an amplitude spectrum value is raised to the power of 0.3; and e represents a natural logarithm base, j represents an imaginary unit, and ψ represents a complex number operator used to calculate an angular frequency; and e^{jψS(t,f)} represents a phase.

Step d: model parameters of the sound source separation model are updated according to the loss value.

In some embodiments, backpropagation may be performed according to the loss value to update the model parameters of the sound source separation model.

Based on the same inventive concept, as an implementation of the above-mentioned method, an embodiment of this application further provides a sound source separation apparatus. This embodiment corresponds to the above-mentioned method embodiment. For ease of reading, this embodiment does not reiterate the detailed content of the above-mentioned method embodiment step by step. However, it should be clarified that the sound source separation apparatus in this embodiment can correspondingly implement all the content in the above-mentioned method embodiment.

An embodiment of this application provides a sound source separation apparatus. FIG. 10 is a schematic structural diagram of the sound source separation apparatus. The sound source separation apparatus 100 includes:
a transformation unit 101, configured to transform an audio signal to be separated from a time-domain signal into a time-frequency domain signal;
a segmentation unit 102, configured to perform frequency band segmentation on the time-frequency domain signal to segment the time-frequency domain signal into a plurality of sub band signals, frequency bands of the plurality of sub band signals being not overlapped;
an acquiring unit 103, configured to acquire spectrum features of the plurality of sub band signals respectively;
a processing unit 104, configured to acquire a spectral mask of at least one sound source in the audio signal to be separated according to the spectrum features of the plurality of sub band signals; and
an output unit 105, configured to acquire an audio signal of the at least one sound source according to the spectral mask of the at least one sound source and the time-frequency domain signal.

As an optional implementation of this embodiment of this application, the transformation unit 101 is specifically configured to perform a short-time Fourier transform on the audio signal to be separated to transform the audio signal to be separated from a time-domain signal into a time-frequency domain signal.

As an optional implementation of this embodiment of this application, the segmentation unit 102 is specifically configured to perform frequency band segmentation on a first frequency band of the time-frequency domain signal based on a first frequency band interval and perform frequency band segmentation on a second frequency band of the time-frequency domain signal based on a second frequency band interval,
where a maximum frequency of the first frequency band is less than a minimum frequency of the second frequency band, and the first frequency band interval is smaller than the second frequency band interval.

As an optional implementation of this embodiment of this application, the segmentation unit 102 is specifically configured to evenly segment the first frequency band of the time-frequency domain signal into 24 sub band signals; evenly segment the second frequency band of the time-frequency domain signal into 12 sub band signals; evenly segment a third frequency band of the time-frequency domain signal into 8 sub band signals; evenly segment a fourth frequency band of the time-frequency domain signal into 8 sub band signals; evenly segment a fifth frequency band of the time-frequency domain signal into 8 sub band signals; and evenly segment a sixth frequency band of the time-frequency domain signal into 2 sub band signals.

The first frequency band, the second frequency band, the third frequency band, the fourth frequency band, the fifth frequency band, and the sixth frequency band are not overlapped and collectively constitute a frequency domain range of the time-frequency domain signal.

As an optional implementation of this embodiment of this application, the acquiring unit 103 is specifically configured to respectively perform feature extraction on the plurality of sub band signals to acquire sub band features of the sub band signals, stack the sub band features of the sub band signals to acquire stacked features, and acquire spectrum features of the sub band signals according to the stacked features.

As an optional implementation of this embodiment of this application, the acquiring unit 103 is specifically configured to perform feature extraction on each sub band signal through a multi-layer perceptron corresponding to each sub band signal to acquire sub band features of each sub band,
where the multi-layer perceptron corresponding to each sub band signal is composed of a root-mean-square normalization layer and a linear layer which are sequentially connected in series.

As an optional implementation of this embodiment of this application, the acquiring unit 103 is specifically configured to model, using a local feature extraction module, each sub band feature of the stacked features in a time dimension to acquire local features composed of temporal features of each sub band signal; perform a transposition operation on the local features to acquire first transposed features; model, using a global feature extraction module, each temporal feature of the first transposed features in a feature stacking dimension to acquire global features composed of the frequency band features of the sub band signals; perform a transposition operation on the global features to acquire second transposed features; perform feature fusion on the second transposed features based on a multi-head self-attention mechanism to acquire a fused feature; and split the fused feature to acquire spectrum features of each sub band signal.

As an optional implementation of this embodiment of this application, the local feature extraction module and/or the global feature extraction module is a dual-path Mamba module. The dual-path Mamba module includes:
a first path, where the first path includes: a first Mamba block, a first root-mean-square normalization layer, and a first adder, an input to the first Mamba block is an input of the dual-path Mamba module, an input to the first root-mean-square normalization layer is an output of the first Mamba block, inputs to the first adder are the output of the first Mamba block and an output of the first root-mean-square normalization layer, and an output of the first adder is an output of the first path;
a second path, where the second path includes: a flipping layer, a second Mamba block, a second root-mean-square normalization layer, and a second adder, the flipping layer is used to flip the input of the dual-path Mamba module, an input to the second Mamba block is an output of the flipping layer, an input to the second root-mean-square normalization layer is an output of the second Mamba block, inputs to the second adder are the output of the second Mamba block and an output of the second root-mean-square normalization layer, and an output of the second adder is an output of the second path;
a concatenation layer, used to concatenate the output of the first path and the output of the second path; and
a linear layer, where an input to the linear layer is an output of the concatenation layer, and an output of the linear layer is an output of the dual-path Mamba module.

As an optional implementation of this embodiment of this application, the processing unit 104 is specifically configured to, for each sound source, process the spectrum features of each sub band signal through a corresponding mask estimation module to acquire a spectral mask of each sub band signal corresponding to the sound source, and concatenate the spectral masks of the sub band signals corresponding to the sound source to acquire a spectral mask of the sound source,
where the mask estimation module corresponding to each sub band is composed of a multi-layer perceptron and a gated linear unit, which are sequentially connected in series, and the multi-layer perceptron is composed of a root-mean-square normalization layer and a linear layer which are sequentially connected in series.

As an optional implementation of this embodiment of this application, the output unit 105 is specifically configured to respectively calculate a product of the time-frequency domain signal and the spectral mask of each sound source to acquire a time-frequency domain signal of each sound source; and transform the time-frequency domain signal of each sound source into a time-domain signal to acquire an audio signal of each sound source.

As an optional implementation of this embodiment of this application, the output unit 105 is specifically configured to perform an inverse short-time Fourier transform on the time-frequency domain signal of each sound source to transform the time-frequency domain signal of each sound source into a time-domain signal.

As an optional implementation of this embodiment of this application, the apparatus includes a sound source separation model. The sound source separation model includes:
a transformation module, configured to transform an audio signal to be separated from a time-domain signal into a time-frequency domain signal;
a segmentation module, configured to implement frequency band segmentation on the time-frequency domain signal;
an acquiring module, configured to acquire spectrum features of the plurality of sub band signals respectively;
a mask estimation module, configured to acquire a spectral mask of at least one sound source in the audio signal to be separated according to the spectrum features of the plurality of sub band signals; and
an output module, configured to acquire an audio signal of the at least one sound source according to the spectral mask of the at least one sound source and the time-frequency domain signal.

As an optional implementation of this embodiment of this application, before the acquiring unit 104 is configured to implement the audio separation method based on the sound source separation model, the method further includes: acquiring a training data set, where the training data set includes: a plurality of groups of training data, and any group of training data includes: a sample audio signal and a reference audio signal of at least one sound source corresponding to the sample audio signal; and training the sound source separation model based on the training data set.

As an optional implementation of this embodiment of this application, the acquiring unit 104 is specifically configured to input the sample audio signal into the sound source separation model and acquire a predicted audio signal of at least one sound source corresponding to the sample audio signal output by the sound source separation model and a time-frequency domain signal of the predicted audio signal of the at least one sound source corresponding to the sample audio signal; acquire a time-frequency domain signal of the reference audio signal of the at least one sound source corresponding to the sample audio signal; calculate a loss value corresponding to the sample audio signal according to the reference audio signal of the at least one sound source corresponding to the sample audio signal, the predicted audio signal of the at least one sound source corresponding to the sample audio signal, the time-frequency domain signal of the predicted audio signal of the at least one sound source corresponding to the sample audio signal, and the time-frequency domain signal of the reference audio signal of the at least one sound source corresponding to the sample audio signal; and update model parameters of the sound source separation model according to the loss value.

The sound source separation apparatus provided in this embodiment of this application may perform the sound source separation method according to any one of the above-mentioned embodiments, sharing similar implementation principles and technical effects, which will not be detailed herein.

Based on the same inventive concept, an embodiment of this application further provides an electronic device. FIG. 11 is a schematic structural diagram of an electronic device according to an embodiment of this application. As shown in FIG. 11, the electronic device according to this embodiment includes a memory 111 and a processor 112. The memory 111 is configured to store a computer program, and the processor 112 is configured to cause, when executing the computer program, the sound source separation method according to the above-mentioned embodiment to be performed.

Based on the same inventive concept, an embodiment of this application further provides a computer-readable storage medium. The computer-readable storage medium has a computer program stored therein that, when executed by a processor, causes a computing device to implement the sound source separation method according to the above-mentioned embodiment.

Based on the same inventive concept, an embodiment of this application further provides a computer program product. The computer program product, when running on a computer, causes a computing device to implement the sound source separation method according to the above-mentioned embodiment.

Those skilled in the art should understand that the embodiments of this application may be provided as a method, a system, or a computer program product. Therefore, this application may adopt a form of a fully hardware-based embodiment, a fully software-based embodiment, or an embodiment that combines software and hardware aspects. In addition, this application may use a form of a computer program product implemented on one or more computer-usable storage media including computer-usable program code.

The processor may be a central processing unit (CPU), another general-purpose processor, a digital signal processor (DSP), an application specific integrated circuit (ASIC), a field-programmable gate array (FPGA), or other programmable logic devices, discrete gates or transistor logic devices, and discrete hardware components. The general-purpose processor may be a microprocessor, or any conventional processor, etc.

The memory may include a volatile memory, a random access memory (RAM), and/or a nonvolatile internal memory, and other forms in the computer-readable medium, such as a read-only memory (ROM) or a flash RAM. The memory is an example of the computer-readable medium.

The computer-readable medium includes permanent and non-permanent, removable and non-removable storage media. The storage medium may store information by any method or technology. The information may be a computer-readable instruction, a data structure, a program module, or other data. Examples of the computer storage medium include, but are not limited to, a phase change memory (PRAM), a static random access memory (SRAM), a dynamic random access memory (DRAM), other types of random access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storage, a magnetic cassette tape, a magnetic disk storage, or other magnetic storage devices, or any other non-transmission medium that may be configured to store information accessible to a computing device. According to the definition herein, the computer-readable medium does not include transitory computer readable media, such as modulated data signals and carrier waves.

Finally, it should be noted that the above-mentioned embodiments are merely used for illustrating rather than limiting the technical solutions of this application; although this application has been described in detail with reference to the above-mentioned embodiments, those of ordinary skill in the art should understand that the technical solutions recorded in the above-mentioned various embodiments may still be modified, or some or all of the technical features may be equivalently substituted; and such modifications or substitutions do not make the essence of the corresponding technical solutions depart from the spirit and the scope of the technical solutions of the various embodiments of this application.

I/We claim:

1. An audio separation method, comprising:
transforming an audio signal to be separated from a time-domain signal into a time-frequency domain signal;
performing frequency band segmentation on the time-frequency domain signal to segment the time-frequency domain signal into a plurality of sub band signals, frequency bands of the plurality of sub band signals being not overlapped;
acquiring spectrum features of the plurality of sub band signals respectively;
acquiring a spectral mask of at least one sound source of the audio signal to be separated according to the spectrum features of the plurality of sub band signals; and
acquiring an audio signal of the at least one sound source according to the spectral mask of the at least one sound source and the time-frequency domain signal.

2. The method according to claim 1, wherein transforming the audio signal to be separated from the time-domain signal into the time-frequency domain signal comprises:
performing a short-time Fourier transform (STFT) on the audio signal to be separated to transform the audio signal to be separated from the time-domain signal into the time-frequency domain signal.

3. The method according to claim 1, wherein performing the frequency band segmentation on the time-frequency domain signal to segment the time-frequency domain signal into the plurality of sub band signals comprises:
performing frequency band segmentation on a first frequency band of the time-frequency domain signal based on a first frequency band interval, and performing frequency band segmentation on a second frequency band of the time-frequency domain signal based on a second frequency band interval, and
wherein a maximum frequency of the first frequency band is less than a minimum frequency of the second frequency band, and the first frequency band interval is smaller than the second frequency band interval.

4. The method according to claim 1, wherein acquiring the spectrum features of the plurality of sub band signals respectively comprises:
performing feature extraction on the plurality of sub band signals respectively to acquire sub band features of each sub band signal;
stacking the sub band features of each sub band signal to acquire stacked features; and
acquiring the spectrum features of each sub band signal according to the stacked features.

5. The method according to claim 4, wherein performing the feature extraction on the plurality of sub band signals respectively to acquire the sub band features of each sub band signal comprises:
performing feature extraction on each sub band signal through a multi-layer perceptron (MLP) corresponding to each sub band signal to acquire the sub band features of each sub band signal,
wherein the MLP corresponding to each sub band signal is composed of a root-mean-square normalization layer and a linear layer which are sequentially connected in series.

6. The method according to claim 4, wherein acquiring the spectrum features of each sub band signal according to the stacked features comprises:
modeling, by a local feature extraction module, each sub band feature of the stacked features in a time dimension to acquire local features composed of temporal features of each sub band signal;
performing a transposition operation on the local features to acquire first transposed features;
modeling, by a global feature extraction module, each temporal feature of the first transposed features in a feature stacking dimension to acquire global features composed of frequency band features of each sub band signal;
performing a transposition operation on the global features to acquire second transposed features;
performing feature fusion on the second transposed features by a multi-head self-attention mechanism to acquire a fused feature; and
splitting the fused feature to acquire spectrum features of each sub band signal.

7. The method according to claim 6, wherein the local feature extraction module and/or the global feature extraction module is a dual-path Mamba module, and the dual-path Mamba module comprises:
a first path, the first path comprising: a first Mamba block, a first root-mean-square normalization layer, and a first adder, an input to the first Mamba block being an input of the dual-path Mamba module, an input to the first root-mean-square normalization layer being an output of the first Mamba block, inputs to the first adder being the output of the first Mamba block and an output of the first root-mean-square normalization layer, and an output of the first adder being an output of the first path;
a second path, the second path comprising: a flipping layer, a second Mamba block, a second root-mean-square normalization layer, and a second adder, the flipping layer being configured to flip the input of the dual-path Mamba module, an input to the second Mamba block being an output of the flipping layer, an input to the second root-mean-square normalization layer being an output of the second Mamba block, inputs to the second adder being the output of the second Mamba block and an output of the second root-mean-square normalization layer, and an output of the second adder being an output of the second path;
a concatenation layer, configured to concatenate the output of the first path and the output of the second path; and
a linear layer, an input to the linear layer being an output of the concatenation layer, and an output of the linear layer is an output of the dual-path Mamba module.

8. The method according to claim 1, wherein acquiring the spectral mask of the at least one sound source of the audio signal to be separated according to the spectrum features of each sub band signal comprises:
for each sound source, processing the spectrum features of each sub band signal by a corresponding mask estimation module to acquire a spectral mask of each sub band signal corresponding to the sound source, and concatenating the spectral mask of each sub band signal corresponding to the sound source to acquire the spectral mask of the sound source, and
wherein the mask estimation module corresponding to each sub band is composed of an MLP and a gated linear unit (GLU) which are sequentially connected in series, and the MLP is composed of a root-mean-square normalization layer and a linear layer which are sequentially connected in series.

9. The method according to claim 1, wherein acquiring the audio signal of the at least one sound source according to the spectral mask of the at least one sound source and the time-frequency domain signal comprises:
calculating a product of the time-frequency domain signal and the spectral mask of each sound source respectively to acquire a time-frequency domain signal of each sound source; and
transforming the time-frequency domain signal of each sound source into a time-domain signal respectively to acquire an audio signal of each sound source.

10. The method according to claim 9, wherein transforming the time-frequency domain signal of each sound source into the time-domain signal respectively comprises:
performing an inverse short-time Fourier transform (ISTFT) on the time-frequency domain signal of each sound source respectively to transform the time-frequency domain signal of each sound source into the time-domain signal.

11. The method according to claim 1, wherein the audio separation method is implemented based on a sound source separation model, and the sound source separation model comprises:
a transformation module, configured to perform a step of transforming the audio signal to be separated from the time-domain signal into the time-frequency domain signal;
a segmentation module, configured to perform a step of performing frequency band segmentation on the time-frequency domain signal to segment the time-frequency domain signal into the plurality of sub band signals;
an acquiring module, configured to perform a step of acquiring spectrum features of the plurality of sub band signals respectively;
a mask estimation module, configured to perform a step of acquiring the spectral mask of the at least one sound source of the audio signal to be separated according to the spectrum features of the plurality of sub band signals; and
an output module, configured to perform a step of acquiring the audio signal of the at least one sound source according to the spectral mask of the at least one sound source and the time-frequency domain signal.

12. The method according to claim 11, wherein before implementing the audio separation method based on the sound source separation model, the method further comprises:
acquiring a training data set, the training data set comprising: a plurality of groups of training data, and any group of training data comprising: a sample audio signal and a reference audio signal of at least one sound source corresponding to the sample audio signal; and
training the sound source separation model based on the training data set.

13. The method according to claim 12, wherein training the sound source separation model based on the training data set comprises:
inputting the sample audio signal into the sound source separation model and acquiring a predicted audio signal of at least one sound source corresponding to the sample audio signal output by the sound source separation model and a time-frequency domain signal of the predicted audio signal of the at least one sound source corresponding to the sample audio signal;
acquiring a time-frequency domain signal of a reference audio signal of the at least one sound source corresponding to the sample audio signal;
calculating a loss value corresponding to the sample audio signal according to the reference audio signal of the at least one sound source corresponding to the sample audio signal, the predicted audio signal of the at least one sound source corresponding to the sample audio signal, the time-frequency domain signal of the predicted audio signal of the at least one sound source corresponding to the sample audio signal, and the time-frequency domain signal of the reference audio signal of the at least one sound source corresponding to the sample audio signal; and
updating model parameters of the sound source separation model according to the loss value.

14. An electronic device, comprising one or more memories and one or more processors, wherein the one or more memories are configured to store instructions, and the one or more processors are configured to cause, when executing the instructions, the electronic device to:
transform an audio signal to be separated from a time-domain signal into a time-frequency domain signal;
perform frequency band segmentation on the time-frequency domain signal to segment the time-frequency domain signal into a plurality of sub band signals, frequency bands of the plurality of sub band signals being not overlapped;
acquire spectrum features of the plurality of sub band signals respectively;
acquire a spectral mask of at least one sound source of the audio signal to be separated according to the spectrum features of the plurality of sub band signals; and
acquire an audio signal of the at least one sound source according to the spectral mask of the at least one sound source and the time-frequency domain signal.

15. The device according to claim 14, wherein instructions causing the device to transform the audio signal to be separated from the time-domain signal into the time-frequency domain signal comprise instructions causing the device to:
performing a short-time Fourier transform (STFT) on the audio signal to be separated to transform the audio signal to be separated from the time-domain signal into the time-frequency domain signal.

16. The device according to claim 14, wherein instructions causing the device to perform the frequency band segmentation on the time-frequency domain signal to segment the time-frequency domain signal into the plurality of sub band signals comprise instructions causing the device to:
perform frequency band segmentation on a first frequency band of the time-frequency domain signal based on a first frequency band interval, and performing frequency band segmentation on a second frequency band of the time-frequency domain signal based on a second frequency band interval, and
wherein a maximum frequency of the first frequency band is less than a minimum frequency of the second frequency band, and the first frequency band interval is smaller than the second frequency band interval.

17. The device according to claim 14, wherein instructions causing the device to acquire the spectrum features of the plurality of sub band signals respectively comprise instructions causing the device to:
perform feature extraction on the plurality of sub band signals respectively to acquire sub band features of each sub band signal;
stacking the sub band features of each sub band signal to acquire stacked features; and
acquiring the spectrum features of each sub band signal according to the stacked features.

18. The device according to claim 17, wherein instructions causing the device to perform the feature extraction on the plurality of sub band signals respectively to acquire the sub band features of each sub band signal comprise instructions causing the device to:
perform feature extraction on each sub band signal through a multi-layer perceptron (MLP) corresponding to each sub band signal to acquire the sub band features of each sub band signal,
wherein the MLP corresponding to each sub band signal is composed of a root-mean-square normalization layer and a linear layer which are sequentially connected in series.

19. The device according to claim 17, wherein instructions causing the device to acquire the spectrum features of each sub band signal according to the stacked features comprise instructions causing the device to:
model, by a local feature extraction module, each sub band feature of the stacked features in a time dimension to acquire local features composed of temporal features of each sub band signal;
perform a transposition operation on the local features to acquire first transposed features;
model, by a global feature extraction module, each temporal feature of the first transposed features in a feature stacking dimension to acquire global features composed of frequency band features of each sub band signal;
perform a transposition operation on the global features to acquire second transposed features;
perform feature fusion on the second transposed features by a multi-head self-attention mechanism to acquire a fused feature; and
split the fused feature to acquire spectrum features of each sub band signal.

20. A non-transitory computer-readable storage medium, having a computer program stored therein that, when executed by a computing device, causes the computing device to:
transform an audio signal to be separated from a time-domain signal into a time-frequency domain signal;
perform frequency band segmentation on the time-frequency domain signal to segment the time-frequency domain signal into a plurality of sub band signals, frequency bands of the plurality of sub band signals being not overlapped;
acquire spectrum features of the plurality of sub band signals respectively;
acquire a spectral mask of at least one sound source of the audio signal to be separated according to the spectrum features of the plurality of sub band signals; and
acquire an audio signal of the at least one sound source according to the spectral mask of the at least one sound source and the time-frequency domain signal.
